(19) United States
(12) Patent Application Publication
(10) Pub. No.: US 2026/0276181 A1
(43) Pub. Date: Sep. 17, 2026

(54) MOUNTING ARRANGEMENT FOR CEILING SUSPENDED SKYLIGHT LUMINAIRES

(71) Applicant: SIGNIFY HOLDING B.V., EINDHOVEN (NL)

(72) Inventor: MARCUS CORNELIS VAN MEEL, HELMOND (NL)

(21) Appl. No.: 19/469,433

(22) PCT Filed: Mar. 20, 2024
(86) PCT No.: PCT/EP2024/057467

§ 371 Date: Sep. 26, 2025

(30) Foreign Application Priority Data
Mar. 28, 2023 (EP) 23164788.4

(51) Int. Cl. F21V 21/008; E04B 9/00

(52) U.S. Cl. CPC F21V 21/008; E04B 9/006

(57) ABSTRACT

The present disclosure relates to a skylight luminaire (1) comprising a circumferential plate (10) and a recessed skylight unit (20) arranged in the circumferential plate (10). The skylight luminaire (1) further comprises fastening elements (11a, 11b) arranged on the circumferential plate (10). A protrusion (21) of the recessed skylight unit (20) forms a rectangular base (21′) on the upper surface (18) of the circumferential plate (10) wherein the rectangular base (21′) extends between a first pair of parallel sides separated in a first direction (L1) and a second pair of parallel sides separated in a second direction (L2) perpendicular to the first direction (L1). The fastening elements (11a, 11b) are arranged at outside of the rectangular base (21′).

### FIELD OF THE INVENTION

The present invention generally relates to a skylight luminaire, also referred to as an artificial skylight, comprising a recessed skylight unit. More specifically, the present invention relates to an improved arrangement for mounting the skylight luminaire to a ceiling.

### BACKGROUND OF THE INVENTION

Light sources adapted to provide artificial daylight are commonly used in office spaces, commercial spaces and even in private homes to illuminate indoor environments with a light that appears natural as if it shines through a window. As people often spend a large portion of the day indoors many people experience daylight for a very limited time which has been shown to negatively affect people's general wellbeing. Light sources that provide artificial daylight have therefore been proposed to provide indoor lighting that mimics the natural daylight available outdoors to improve the wellbeing of people that spend much time indoors.

In some examples, light sources with controllable color (e.g. color temperature) and light intensity are installed in an indoor space whereby the color and light intensity are controlled to mimic the rising and setting of the sun. For instance, the color of the controllable light sources is adjusted to appear redder and more orange closer to dusk and dawn and more white closer to noon and/or the intensity is controlled to provide higher intensity at noon and lower intensity closer dusk and dawn.

Another approach for providing artificial daylight indoors is by providing artificial windows that provide a convincing lighting effect that make it appear that a room is well lit by natural light shining through a window. To this end, artificial skylights have been proposed having a recessed light unit with a horizonal sky section that emits a primarily blue light which is circumferentially surrounded by vertical sun section emitting a substantially white light. With this type of artificial skylight, a very convincing illumination effect is achieved since people close to the artificial skylight (e.g. right below the skylight) will be able to see what appears to a blue sky in the recessed light unit. At the same time, the sun section makes it appear like sunlight is shining through the sky section and being reflected off the vertical sky section. Together the sky section and sun section make it appear like natural light shines through the skylight into the indoor space. Artificial skylights of this type are very convenient to use since they can be installed against a ceiling at many locations without occupying any floor or wall space. Accordingly, artificial skylights can provide artificial daylight at many locations indoors, and are especially suitable for use in rooms or spaces with little to no natural light coming from regular windows.

A drawback with artificial skylights is that the installation process can still be cumbersome and labor intensive. Each artificial skylight may comprise many individual pieces that need to be assembled and suspended from a ceiling using many wires spread out across the artificial skylight. This makes installing an artificial skylight to a e.g. a ceiling provided with a ceiling grid system especially difficult since many grid plates must be removed or modified to allow suspension of the artificial skylight.

CN112984424A discloses a lamp for simulating sky and comprising a blue sky lamp and, a sunlight lamp arranged on an external structure.

### SUMMARY OF THE INVENTION

It is an object of the present invention to provide a skylight luminaire which overcomes the drawbacks mentioned in the above and which is more convenient to install against a ceiling, even when the ceiling is provided with a ceiling grid system. These and other objects may be achieved by a skylight luminaire in accordance with the independent claim. Embodiments of the present invention are defined in the dependent claims.

Hence, according to an aspect of the present invention, there is provided a skylight luminaire comprising a circumferential plate, a recessed skylight unit arranged in the circumferential plate, the recessed skylight unit forming a recess in a lower surface of the skylight luminaire and a protrusion on an upper surface of the skylight luminaire. The skylight luminaire further comprises at least two fastening elements arranged on the upper surface of the circumferential plate. Each fastening element is configured to enable suspension of the skylight luminaire from a ceiling, e.g. the fastening element is a wire gripper. The protrusion forms a rectangular base on the upper surface of the circumferential plate and the rectangular base extends between a first pair of parallel sides separated in a first direction and extends between a second pair of parallel sides separated in a second direction substantially perpendicular to the first direction. Wherein the at least two fastening elements are arranged outside the rectangular base.

Thus, the present invention is based on the idea that placement of the fastening elements outside of the rectangular base, on the circumferential plate, is associated with many benefits. Firstly, the fastening elements will not increase the total height of the skylight luminaire (compared to arrangement of the fastening elements on top of the protrusion, i.e. withing the rectangular) which facilitates efficient packaging, transportation and storage of the skylight luminaire. Secondly, the fastening elements can be arranged close to the center of mass and the structurally strongest part of the skylight luminaire (the region in proximity to the recessed skylight unit).

The terms such as “horizontal”, “vertical”, “upper surface”, “lower surface” are here used to indicate orientation when the skylight is mounted in a ceiling. So, even in a non-mounted state, where the upper surface of the circumferential plate may have a different orientation, this surface of the circumferential plate is still referred to as the upper surface.

By a “circumferential plate” is here meant a substantially flat plate that surrounds the recessed skylight unit on at least two sides of the recessed skylight unit. The circumferential plate may be hollow or may have concavities in its upper surface down to its lower surface and may completely surround the recessed skylight unit and e.g. be substantially square shaped. Alternatively, the circumferential plate is rectangular and extends away further from the recessed skylight unit in the first direction compared to in the second direction.

The circumferential plate may be attached to the recessed skylight unit. For example, it is envisaged that the circumferential plate and the recessed skylight unit forms a single device. This means that it is not necessary to assemble the skylight luminaire prior to installation, the skylight luminaire is simply suspended from ceiling as a regular luminaire.

According to an embodiment, the skylight luminaire comprises at least two pairs of fastening elements, the two pairs of fastening elements being arranged outside the rectangular base. Preferably, each fastening elements of each pair is separated with a separation distance.

That is, at least four fastening elements can be used to suspend the skylight luminaire which enables a leveled and safe installation.

According to an embodiment, the at least two fastening elements are arranged at opposite sides of the rectangular base in the first direction, and each fastening element is arranged within a width of the protrusion in the second direction.

This arrangement of the fastening elements adds yet another benefit, as fastening elements provided within the width of the protrusion's base in the second direction enables the skylight luminaire to be used in a suspended surface mounted installation for ceilings provided with a ceiling grid, while also allowing for maximum size of the recessed skylight unit and minimization of the number of grid plates that need to be removed or manipulated (e.g. split or provided with one or more cut-outs).

If at least two pairs of fastening elements are used the fastening elements of each pair may be separated mainly or only in a direction parallel with the second direction. For example, this enables a section of a grid cover plate to be cut to make room for the wires going from the ceiling to the fastening elements. The cut portion of the ceiling plate will not be visible after installation since this portion is covered by the circumferential plate.

According to an embodiment, the rectangular base is substantially square. Since most ceiling grids comprise equidistantly spaced bars that form square shaped grid openings, it is possible to maximize the size of the recessed skylight unit (and the associated protrusion) while still making it insertable in ta square grid opening if the recessed skylight unit, or at least the protrusion, is substantially square. The protrusion as such may be shaped substantially like box, such as a cube or oblong, protruding from the upper surface of the circumferential plate.

According to an embodiment, the width of the base is below 625 mm, preferably between 550 mm and 625 mm. As most common ceiling grids comprise square openings with a side length of less than 625 mm, the width of the protrusions base is preferably less than 625 mm to fit inside a square opening.

According to an embodiment, a distance in the first direction between fastening elements on opposing sides of the base is less than 700 mm, preferably less than 670 mm.

Additionally or alternatively, a distance in the first direction between fastening elements on opposing sides of the base is at least 615 mm, preferably at least than 650 mm.

That is, the fastening elements on opposite sides of the base are arranged so as fit inside two different square openings in a ceiling grid when the skylight luminaire is installed into the ceiling grid, the two square openings being separated by an intermediate square opening into which the protrusion is inserted. For example, the first direction distance between fastening elements on opposite sides of the base should be more than the width of a square opening in the ceiling grid plus two times the width of a gird bar but not more than three times the width of a square opening in the ceiling grid plus two times the width of a gird bar.

According to an embodiment, the skylight luminaire further comprises a luminaire driver arranged on the upper surface of the circumferential plate, the luminaire driver being configured to drive at least a light element of the recessed skylight unit.

With the luminaire driver arranged on the upper surface of the skylight luminaire, the luminaire driver is hidden from view when the skylight luminaire is suspended from the ceiling which makes the skylight luminaire more visually appealing while the luminaire driver is protected. Additionally, the luminaire driver may also protrude some distance from the upper surface of the circumferential plate meaning that when the driver is arranged on the upper surface the maximum height of the skylight luminaire is reduced, which facilitates space efficient packaging, storage and transportation.

According to an embodiment, the luminaire driver is arranged within the width of the rectangular base. That is, the luminaire driver can fit inside a square opening in a ceiling grid which means that the skylight luminaire can be installed close to the ceiling.

According to an embodiment, the luminaire driver is arranged such that at least one fastening element lies between the rectangular base and the luminaire driver along the first direction. Preferably, the luminaire driver is arranged close to the fastening element such that the fastening elements of one side of the protrusion and the luminaire driver can be fitted inside a single square opening in a ceiling grid. This enables the fastening elements to support the skylight luminaire close to the structurally strongest part (in proximity to the recessed skylight unit) while still a minimum number of grid plates needs to be removed and/or manipulated.

According to an embodiment the circumferential plate comprises a light module arranged in a concavity in the upper surface of the circumferential plate as to rest on the lower surface of the circumferential plate and configured to spread (functional) light more evenly over the lower surface of the circumferential plate, the light module may be covered with a diffuser at a light module light exit window. While the recessed skylight unit provides a visually pleasing illumination effect and convincingly appears like a real skylight window, additional light may be needed to properly illuminate the indoor environment for e.g. office use. The recessed skylight unit is thus complemented by the light module of the circumferential plate, the latter may be configured to provide more conventional indoor illumination often referred to as “functional light”. The circumferential plate and the recessed skylight unit may be provided as a single device meaning that both functional lighting and artificial skylight is provided by a single ceiling suspended unit. The lighting module of the circumferential plate may also be powered and/or controlled by the luminaire driver.

According to a second aspect of the present invention there is provided a grid formed by a plurality of spaced apart longitudinal bars and a plurality of spaced apart transverse bars, extending perpendicular to the longitudinal bars, the grid extending in a plane that is substantially parallel to a ceiling, and a skylight luminaire according to the first aspect, wherein at least the protrusion is configure to be arranged between two adjacent longitudinal bars and two adjacent transverse bars with the upper surface facing the ceiling.

As will be described in the below with “a skylight luminaire arranged between two adjacent longitudinal bars and two adjacent transverse bars of the ceiling grid” it is meant that at least a portion (such as the circumferential plate or the protrusion) is arranged between four bars forming an opening in the ceiling grid. With the fastening elements arranged as described in the above, the skylight luminaire is especially suitable for space efficient and simple integration in ceiling grids.

In one embodiment of the second aspect, the grid comprises a plurality of square openings, and wherein the skylight luminaire is configured to be arranged with the circumferential plate arranged on a lower side of the grid and the protrusion extending through a square opening of the grid. This type of installation is sometimes referred to as suspended surface mounted installation and has the benefit of being very easy to achieve by only removing and/or manipulating three grid plates while also the skylight luminaire does not extend to far from the ceiling grid since protrusion is received in a grid opening.

Preferably, each fastening element is placed on an opposite side of a transverse bar from the protrusion's base. This allows the protrusion of the recessed skylight unit to be made as large as possible while still fitting inside a grid opening since there is no need to encompass the fastening elements within the same grid opening.

In one embodiment of the second aspect the grid comprises a plurality of square openings and the circumferential plate of the skylight luminaire is configured to be fitted inside a square grid opening so as to extend substantially parallel to the grid. This type of installation is sometimes referred to as suspended recessed installation and a benefit with this type of installation is that the skylight luminaire does extend from ceiling grid at all, but rather appears to be wholly integrated into the ceiling grid.

### BRIEF DESCRIPTION OF THE DRAWINGS

This and other aspects of the present invention will now be described in more detail, with reference to the appended drawings showing embodiments of the present invention.

FIG. 1 schematically shows a perspective view of a skylight luminaire according to an exemplifying embodiment of the present invention.

FIG. 2 shows a side view of the skylight luminaire suspended from a ceiling and arranged between grid plates of a ceiling grid according to an exemplifying embodiment of the present invention.

FIG. 3 is a top-down view of a skylight luminaire arranged in a ceiling grid according to an exemplifying embodiment of the present invention.

FIG. 4a shows a skylight luminaire suspended below a ceiling grid according to an exemplifying embodiment of the present invention.

FIG. 4b shows a skylight luminaire lifted into the ceiling grid after being suspended below the ceiling grid according to an exemplifying embodiment of the present invention.

FIG. 5a shows a skylight luminaire with fastening elements arranged on top of the protrusion suspended below a ceiling grid.

FIG. 5b shows a skylight luminaire with fastening elements arranged on top of the protrusion lifted into the ceiling grid after being suspended below the ceiling grid.

FIG. 6 shows a skylight luminaire installed in a ceiling grid with the circumferential plate substantially flush with the ceiling grid in a suspended recessed installation according to an exemplifying embodiment of the present invention.

FIG. 7 shows a skylight luminaire installed in a ceiling grid with the circumferential plate arranged below, and the protrusion arranged substantially within, the ceiling grid in a suspended surface mounted installation according to an exemplifying embodiment of the present invention.

FIG. 8 shows a skylight luminaire suspended from a ceiling in a suspended open ceiling installation according to an exemplifying embodiment of the present invention.

### DETAILED DESCRIPTION

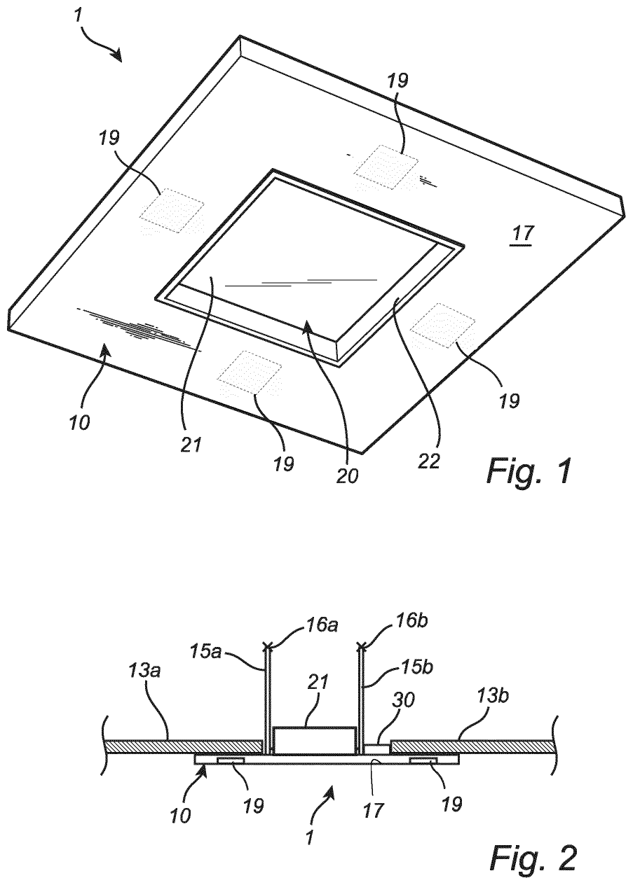

FIG. 1 schematically shows a perspective view of a skylight luminaire 1. The skylight luminaire 1 comprises a circumferential plate 10 and a recessed skylight unit 20 arranged in the circumferential plate 10. The circumferential plate 10 is substantially flat and preferably rectangular or square. The circumferential plate 10 is provided with a rectangular or square opening in which a recessed skylight unit 20 is arranged.

The rectangular or square opening may be arranged in the center of the circumferential plate 10. It is also envisaged that the rectangular or square opening can be arranged off-center or at an edge of the circumferential plate 10. For example, two skylight luminaires 1 can be installed next to each other with the recessed skylight unit 20 of each skylight luminaire 1 being adjacent to each other.

The recessed skylight unit 20 may comprise a horizontal sky section 21 and one or more sun vertical sections 22 arranged around the horizontal sky section 21. The horizontal sky section 21 is configured to emit a blue light (similar to that of a blue sky) and the one or more vertical sun sections 22 is configured to emit a white or white/yellow light making it appear like sun light is striking the one or more vertical sun sections 22 and a blue sky is visible through a horizontal window. It is desirable to have an as large recessed skylight unit 20 as possible to provide the most convincing artificial skylight effect. However, as the recessed skylight unit 20 is made larger, the associated protrusion also becomes larger which makes it difficult to fit the protrusion inside the openings formed in traditional ceiling grids. Therefore it is important to provide a suspension arrangement that does not compete with the protrusion for space inside a single grid opening.

Optionally, the circumferential plate 10 is also provided with one or more downwards facing light modules 19 (indicated in ghost). For example, the circumferential plate 10 is provided with light elements covered with a diffuser, which here is the lower surface 17 itself and is configured to spread the light more evenly over the lower surface 17 of the circumferential plate 10. In this way, the circumferential plate 10 can provide functional light suitable for office spaces while the recessed skylight unit 20 provides a light that appears to be natural light, as if it originates from a sunny outside environment shining through a skylight window.

The recessed skylight unit 20 is a three dimensional component forming a recess in the lower surface 17 of the luminaire 1 and a protrusion on the upper surface of the luminaire 1. To avoid reducing the ceiling heigh when the skylight luminaire 1 is suspended from a ceiling it is preferable if the protrusion could be received in a hollow space in the ceiling. Often, the skylight luminaire 1 is installed in ceiling grid comprising elongated bars (T-bars) extending perpendicular to each other forming a grid with square grid openings which is suitable for receiving grid panels (e.g. made of an acoustically absorbing material) and/or different types of luminaires, such as traditional LED or fluorescent tube luminaires.

In FIG. 2, the skylight luminaire 1 is installed in a ceiling grid between two grid panels 13a, 13b. As seen, the circumferential plate 10 is arranged on the lower side of the grid plates 13a, 13b whereas the protrusion 21 of the recessed skylight unit is inserted into the ceiling grid, between the grid bars and acoustic plates 13a, 13b. This reduces the distance with which the skylight luminaire 1 protrudes from the ceiling which is beneficial, especially when ceiling height is limited. The skylight luminaire 1 may be heavy (e.g. weighing about 30 kilograms), and be unsuitable for direct fastening to the grid bars, meaning that the skylight luminaire 1 may be attached to the actual ceiling (from which the ceiling grid is suspended) to be properly and safely suspended.

Suspension of the skylight luminaire 1 may be achieved using wires 15a, 15b that are attached to the ceiling at attachment points 16a, 16b at first and end and to fastening elements mounted on the upper surface of the skylight luminaire 1 at a second end. Alternatively, the fastening elements are configured to grip a rod or a chain attached to the ceiling to enable suspension of the skylight luminaire 1.

The height with which the protrusion 21 extends from the circumferential plate 10 varies depending on the thickness of the circumferential plate 10 and the type of recessed skylight unit. In some implementations, the height with which the protrusion 21 extends above the circumferential plate is between 50 mm and 150 mm, such as about 100 mm. Downward facing light modules 19, i.e. with light module light exit windows facing downward, are provided on the lower surface 17 of the circumferential plate 10.

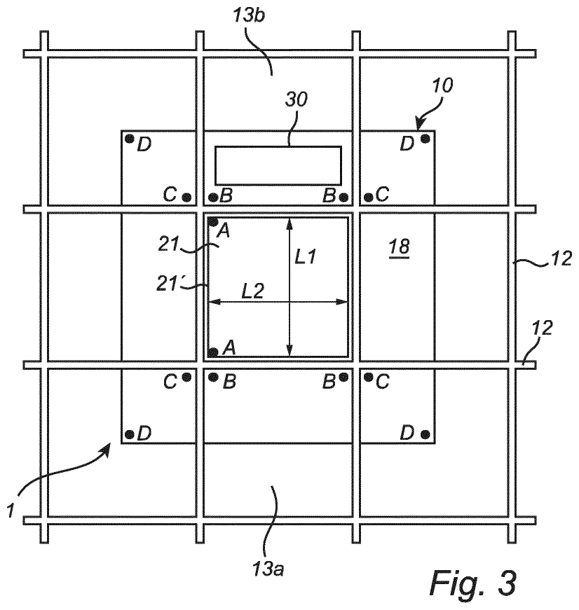

In FIG. 3 a top-down view of the skylight luminaire arranged below a ceiling grid in a suspended surface mounted installation is shown. Alternative positions of the fastening elements on the upper surface 18 of the circumferential plate outside the rectangular base 10 is shown at points B, C and D. The protrusion 21 of the recessed skylight unit forms a rectangular base 21′ in upper surface 18 of the circumferential plate 10. The rectangular base 21′ extends between a first pair of parallel sides separated in a first direction L1 and extending between a second pair of parallel sides separated in a second direction L2 substantially perpendicular to the first direction L1 and the fastening elements at location B are arranged at opposite sides of the base 21′ in the first direction L1, and each fastening element at location B is arranged within a width of the base 21′ in the second direction L2. Fastening elements located at positions C and D are arranged outside the width of the rectangular base 21′ and also outside of the rectangular base 21′.

The fastening means may be in the form of wire grippers (also called suspension grippers) configured to grip a wire suspended from the ceiling. A wire gripper may e.g. be in the form of a cylinder that is attached to the circumferential plate 10 and having a through opening through which a wire can be led. The wire gripper further comprises gripping or clamping means for releasably engaging the wire. By releasing the gripping or clamping means the wire can be pulled through the wire gripper so as to e.g. adjust the suspension height of the skylight luminaire 1 from the ceiling. When a suitable suspension height is achieved the gripping or clamping means are brought into engagement with the wire to lock the wire gripper against the wire. The gripping or clamping means may e.g. be in the form a screw that enters into the through opening to engage the wire.

This placement of the fastening elements at either one of locations B, C or D is associated with multiple benefits. Position B (within the width of the rectangular base) is especially beneficial as will now be described. For positions B, C and D, the fastening elements are arranged on the upper surface 18 of the circumferential plate 10 which means that skylight luminaire 1 has a smaller total height compared to if the fastening elements were arranged on top of the protrusion 21, indicated as location A. For positions B and C, the fastening elements are arranged close to the recessed skylight unit which often is the structurally strongest part of the skylight luminaire 1. By comparison, if the fastening elements instead are arranged further away from the base 21 (e.g. at position D) the skylight luminaire 1 may require reinforcement elements since the skylight luminaire 1 is weaker further from the recessed skylight unit.

For position B, wherein the fastening elements are located within the width of the protrusion's base 21′ it is possible to have a protrusion 21 which occupies and entire grid opening while still minimizing the total number of acoustic plates that need to be modified or removed to suspend the skylight luminaire 1. By comparison, fastening elements arranged at points C are rather close to the structurally strongest part of the skylight luminaire 1 and allows the total height of the skylight luminaire 1 to be reduced since the fastening elements at location C are not provided on the protrusion 21. On the other hand, placement of the fastening elements at location C requires four grid plates 13a, 13b to be provided with cut-outs for passing a wire from the ceiling to a fastening element. In addition, to receive the protrusion 21, at least one grid plate 13a, 13b must be removed or provided with a cut-out, meaning that with the fastening elements located at position C or D outside the width of the base 21′ five acoustic plates must be removed and/or provided with a cut-out. By comparison, with the fastening elements arranged a position B within the width of the base 21′ only three grid plates 13a. 13b need to be removed and/or provided with a cut-out which saves time and makes the installation process less cumbersome.

In FIG. 3, one pair of fastening elements at location B are arranged on either side of the protrusion's base 21′ wherein the fastening elements of each pair are separated with some separation distance. It is also envisaged that only one fastening element is arranged on either side of the protrusion's base 21′, or that one pair of fastening element is arranged on one side and one fastening element arranged on the opposite side.

In some implementations, the skylight luminaire 1 further comprises a luminaire driver 30 which is arranged on the upper surface 18 of the circumferential plate 10. The luminaire driver 30 is configured to provide power to and/or control at least the recessed skylight unit. The circumferential plate 10 may also comprise an additional light module and in such embodiments the luminaire driver 30 may be configured to power and/or control the additional light module of the circumferential plate 10 as well, in addition to the recessed skylight unit.

Preferably, the luminaire driver 30 is arranged wholly within the width of the protrusion base 21′ on the same side of the protrusion base 21′ as one of the fastening elements/fastening element pairs at location B. This means that the luminaire driver 30 can be received wholly within a grid opening together with the fastening element(s) in the ceiling grid and that the number of grid plates that need to be removed and/or provided with a cut-out remains at three, even if the luminaire driver also protrudes from the upper surface 18 of the circumferential plate 10.

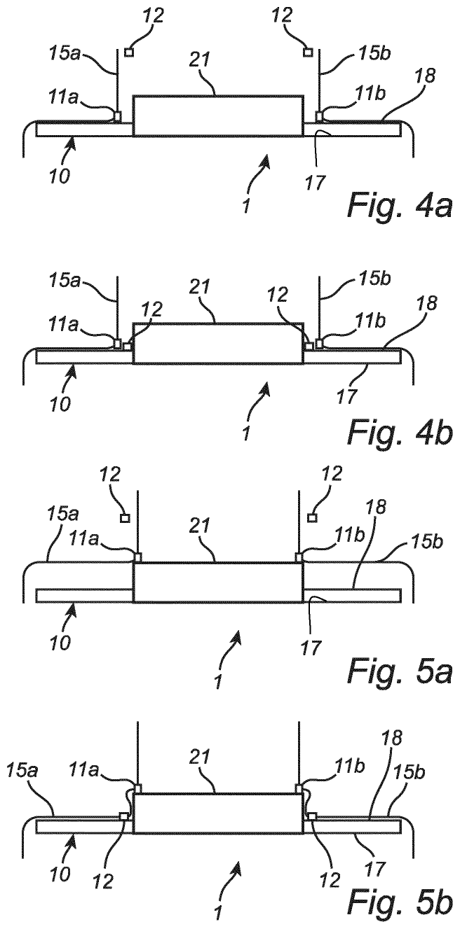

FIG. 4a shows schematically a skylight luminaire 1 in the process of being mounted to a ceiling provided with a ceiling grid. The ceiling grid is formed by a grid of bars 12 (e.g. T-bars) and the skylight luminaire 1 is first suspended below the ceiling grid from wires 15a, 15b mounted to the ceiling. Each wire 15a, 15b is connected to a fastening element 11a, 11b arranged at locations B, C or D in accordance with FIG. 3. To raise the skylight luminaire 1 into the ceiling grid, the wires 15a, 15b can be pulled through the fastening elements 11a, 11b such that the protrusion 21 enters the space between two gird bars 12, as seen in FIG. 4b.

In FIG. 5a and FIG. 5b the equivalent suspension of the skylight luminaire 1 is depicted with the fastening elements 11a, 11b mounted on top of the protrusion 21 instead (this mounting position is labeled position A in FIG. 3). By comparing FIG. 5b with FIG. 4b is seen that a further benefit with using mounting positions B, C or D is that the wire 15a, 15b used for suspending the skylight luminaire 1 becomes more easily accessible, which facilitates easy and efficient installation of the skylight luminaire 1. In FIG. 5b, where fastening elements at position A are used, the wires 15a, 15b may be become stuck between a ceiling grid bar 12 and the circumferential plate 10 when the skylight luminaire is lifted towards the ceiling, this makes installation more difficult. By comparison, with fastening elements at position B, C or D, the wires 15a, 15b do not become stuck between the circumferential plate 10 and the ceiling grid bars 12. Accordingly, a further benefit with arranging the fastening elements 11a, 11b at positions B, C or D is that suspension wire management becomes much easier.

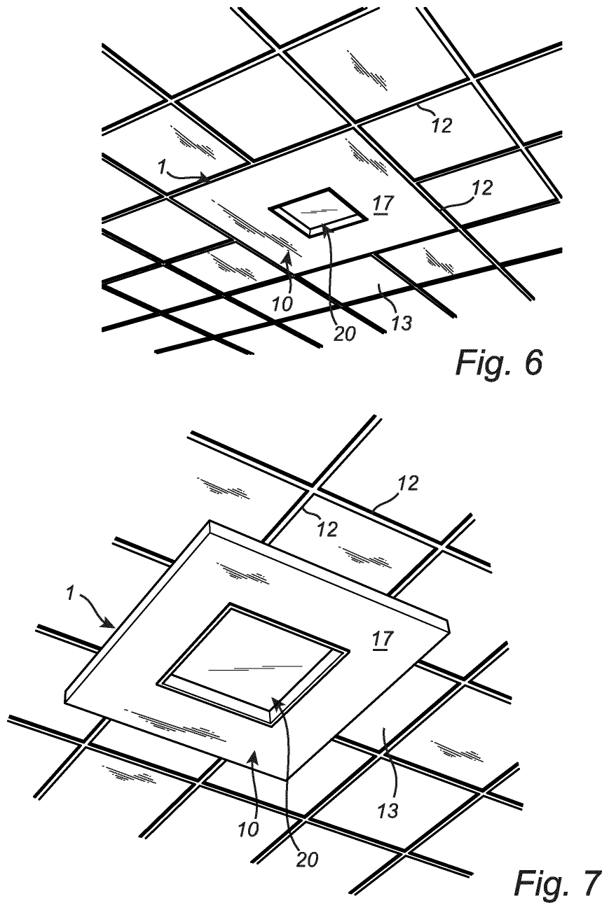

FIG. 6 shows an example of a ceiling system comprising a grid formed by a plurality of spaced apart longitudinal and transverse grid bars 12. A skylight luminaire 1 is arranged between two adjacent longitudinal bars 12 and two adjacent transverse bars 12 with the upper surface facing the ceiling behind the ceiling grid.

In some implementations, the grid openings formed by the ceiling grid are large enough to encompass the entire circumferential plate 10 of the skylight luminaire 1 whereby the skylight luminaire can be used in a suspended recess installation shown in FIG. 6. In a suspended recess installation, the circumferential plate 10 is arranged substantially flush with the ceiling grid wherein the recessed skylight unit 20 forms a recess in the circumferential plate 10 and the ceiling grid. It is also envisaged that the circumferential plate 10 is larger than a square opening, for example the size of four square openings arranged in a square, whereby a part of one or more bars 12 is removed to make room for the skylight luminaire 1 in a suspended recess installation.

FIG. 7 shows schematically a ceiling system with a skylight luminaire 1 in a suspended surface mounted installation. In a suspended surface mounted installation the protrusion is sized and adapted to fit inside a single square grid opening between the bars 12 in the ceiling grid. In this type of installation, the circumferential plate 10 is arranged below the ceiling grid at least partially covering one or more square openings (filled with plates 13) in the ceiling grid. To enable use of a recessed skylight unit 20 that is as large as possible, the protrusion on the upper surface of the skylight luminaire 1 covers essentially all the space of one square grid opening.

Typically, the bars 12 have a width of 15 mm or 24 mm and are arranged at a center-to-center distance of between 600 mm and 650 mm. For bars 12 with a width of 15 mm arranged at 600 mm distance this gives 585 mm square openings and for bars 12 with a width of 15 mm arranged at 650 mm this gives 635 mm square openings. Similarly, for bars 12 with a width of 24 mm arranged at 600 mm distance this gives 576 mm square openings and for bars 12 with a width of 24 mm arranged at 650 mm this gives 626 mm square openings.

Accordingly, the protrusion of the recessed skylight unit 20 may have a base that is square with a between 577 mm and 635 mm (such as about 595 mm) depending on the width and separation distance of the grid bars. It is preferable that the recessed skylight unit 20 (and therefore also the protrusion) is as large as possible while still being able to fit inside a single grid opening in the ceiling grid to provide the most impressive artificial skylight effect while still enabling the skylight luminaire 1 to be installed in a suspended surface mounted installation.

Likewise, it is preferable that the distance along the first direction between two fastening elements arranged on opposite sides of the base of the protrusion is larger than the center-to-center distance between two bars plus the width of one bar such that the fastening elements become arranged in respective square openings that are different from the square opening in which the protrusion is arranged. On the other hand, the distance along the first direction between two fastening elements arranged on opposite sides of the base of the protrusion is preferably as small as possible while satisfying the above requirement to be as close to the structurally strongest portion of the skylight luminaire 1 as possible (namely the region surrounding the recessed skylight unit).

The above mentioned measurements of the width and center-to-center separation distance of the bars 12 of the ceiling grid are merely exemplary and it is understood the dimensions of the recessed skylight unit 20, and its associated upper surface protrusion, can be altered accordingly, if wider/narrower bars 12 are used and/or if bars 12 with different center-to-center spacings are used in the ceiling grid.

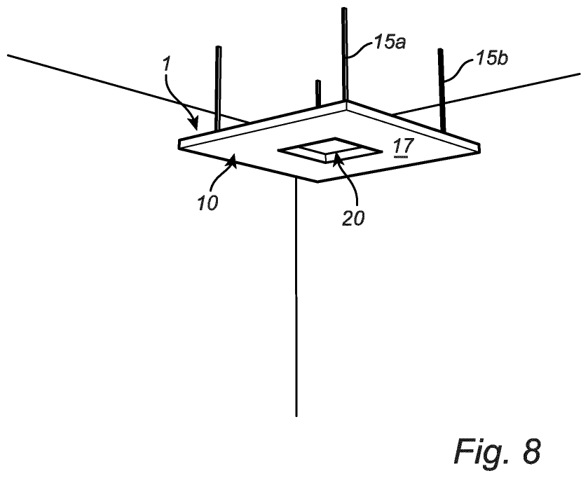

FIG. 8 depicts a skylight luminaire installed suspended from a ceiling in a suspended open ceiling installation. While the above described arrangement of the fastening elements (at location B shown in FIG. 3) is especially well suited for suspended surface mounted installation in a ceiling provided with a ceiling grid the same arrangement of fastening elements can also be used to install the skylight luminaire suspended directly from an open ceiling. The arrangement of the fastening elements on the circumferential plate 10 still provides the benefit of a smaller total height of the skylight luminaire 1 allowing it to be packaged, transported or stored in a space efficient manner. Additionally, this also allows the skylight luminaire 1 to be suspended much closer to the ceiling. For instance, the skylight luminaire 1 can be installed with the protrusion abutting or being immediately adjacent to the ceiling.

Furthermore, the fastening elements are arranged closer to the structurally strongest part of the skylight luminaire which enhances safety. When two pairs of fastening elements is used, and the fastening elements of each pair are separated, preferably only in a direction parallel with the second direction, the skylight luminaire 1 is suspended from four points, meaning that the skylight luminaire 1 can easily be leveled with the ceiling.

The person skilled in the art realizes that the present invention by no means is limited to the preferred embodiments described above. On the contrary, many modifications and variations are possible within the scope of the appended claims. For example, the circumferential plate 10 may be arranged only on the two sides of the protrusion where fastening elements are attached and/or on the two sides of the protrusion where fastening elements are attached and one additional side meaning that two or more skylight luminaires can be arranged side by side in a ceiling grid, giving the impression of a single skylight that spans multiple grid in a ceiling grid.

1. A skylight luminaire comprising:
a circumferential plate,
recessed skylight unit arranged in the circumferential plate, the recessed skylight unit forming a recess in a lower surface of the skylight luminaire and a protrusion on an upper surface of the skylight luminaire, and
at least two fastening elements arranged on the upper surface of the circumferential plate, each fastening element being configured to enable suspension of the skylight luminaire from a ceiling,
wherein the protrusion forms a rectangular base on the upper surface of the circumferential plate, the rectangular base extending between a first pair of parallel sides separated in a first direction and extending between a second pair of parallel sides separated in a second direction substantially perpendicular to the first direction,
wherein said at least two fastening elements are arranged outside the rectangular base, and
wherein the circumferential plate is provided with one or more light modules configured to spread light more evenly over the lower surface of the circumferential plate,
wherein the at least two fastening elements comprise two pairs of fastening means, the two pairs of fastening elements being arranged outside the rectangular base, and
wherein the at least two fastening elements are arranged at opposite sides of the rectangular base on the first direction, and each fastening element is arranged within a width of the protrusion the second direction.

2. (canceled)

3. (canceled)

4. The skylight luminaire according to claim 1, wherein the rectangular base is substantially square shaped.

5. The skylight luminaire according to claim 1, wherein the width is <=625 mm.

6. The skylight luminaire according to claim 1, wherein a distance in the first direction between fastening elements on opposing sides of the base is <=700 mm.

7. The skylight luminaire according to claim 1, wherein a distance in the first direction between fastening elements on opposing sides of the base is at least 615 mm.

8. The skylight luminaire according to claim 1, further comprising a luminaire driver arranged on the upper surface of the circumferential plate, the luminaire driver being configured to drive at least a light element of the recessed skylight unit.

9. The skylight luminaire according to claim 8, wherein the luminaire driver is arranged within the width of the rectangular base.

10. The skylight luminaire according to claim 8, wherein the luminaire driver is arranged such that at least one fastening element lies between the rectangular base and the luminaire driver along the first direction.

11. The skylight luminaire according to claim 1, wherein each fastening element is a wire gripper, configured to grip a wire suspended from the ceiling.

12. A ceiling lighting system comprising:
a grid formed by a plurality of spaced apart longitudinal bars and a plurality of spaced apart transverse bars, extending perpendicular to the longitudinal bars, the grid extending in a plane that is substantially parallel to a ceiling, and
the skylight luminaire according to claim 1, wherein at least the protrusion is configured to be arranged between two adjacent longitudinal bars and two adjacent transverse bars with the upper surface facing the ceiling.

13. The ceiling system according to claim 12, wherein the grid comprises a plurality of square openings, and wherein the skylight luminaire is configured to be arranged with the circumferential plate arranged on a lower side of the grid and the protrusion extending through a square opening of the grid.

14. The ceiling system according to claim 12, wherein the grid comprises a plurality of square openings, and wherein the circumferential plate the skylight luminaire is configured to be fitted inside a square opening so as to extend substantially parallel to the grid.
